(19) United States
(12) Patent Application Publication
(10) Pub. No.: US 2018/0190057 A1
(43) Pub. Date: Jul. 5, 2018

(54) LOCKING AND INTERLOCKING DEVICE

(71) Applicant: Deutsche Telekom AG, Bonn (DE)

(72) Inventors: Sebastian Heinz, Bonn (DE); Michael Schmidt-Gabriel, Wessling (DE); Johannes Scholl, Munich (DE); Joerg Windheuser, Dusseldorf (DE)

(21) Appl. No.: 15/557,478

(22) PCT Filed: Mar. 12, 2015
(86) PCT No.: PCT/EP2015/000551

§ 371 Date: Jan. 26, 2018

(51) Int. Cl. G07C 9/00; E05B 47/00; E05B 67/00

(52) U.S. Cl. CPC G07C 9/00722; E05B 47/0002; G07C 9/00309; G07C 2009/00539; E05B 2047/0095; E05B 2047/0058; E05B 67/003

(57) ABSTRACT

A lock device includes: a first lock body; and a second lock body; wherein the first and second lock bodies are configured to be interlocked. The lock device further includes: an electromagnetic locking device, formed separately from the first and second lock bodies, wherein a first portion of the electromagnetic locking device is configured to be inserted into the first lock body, and a second portion of the electromagnetic locking device is configured to be inserted into the second lock body, and wherein each of the first and second portions of the electromagnetic locking device comprises a latching element, wherein each latching element is configured to lock a respective portion of the electromagnetic locking device to a respective lock body.

### CROSS-REFERENCE TO RELATED APPLICATIONS

This application is a U.S. National Phase application under 35 U.S.C. § 371 of International Application No. PCT/EP2015/000551, filed on Mar. 12, 2015. The International Application was published in German on Sep. 15, 2016 as WO 2016/141948 A2 under PCT Article 21(2).

### FIELD

The invention relates to a lock device, in particular a padlock or a bicycle lock, comprising a first lock body and a second lock body, the first and second lock bodies being interlockable. The invention also relates to a locking device of a lock device.

### BACKGROUND

Lock devices are known in the prior art, e.g. in a typical design as a padlock or a bicycle lock, or generally as a lock device for securing movable objects.

In the usual embodiment, lock devices of this type comprise two lock bodies that can be interconnected and interlocked so that it is not possible to separate the lock bodies at the place provided for this purpose.

In the case of a padlock, the lock bodies are formed by a first body that includes the locking device, e.g. in the style of a cylinder lock or combination lock, and by a second lock body that is formed by a shackle. One end of a shackle of this kind that forms the second lock body is typically movably, but not detachably, connected to the first lock body, the locking device that interlocks the two lock bodies being inseparably integrated in the first lock body.

Locking devices of the kind in which a shackle forms a second lock body that can be completely removed from the first lock body are also known in the prior art, e.g. in the application thereof to secure bicycles. In the case of this design, however, the entire closing mechanism of a locking device is also inseparably integrated in the first lock body.

A lock device according to the prior art thus always forms a self-contained functional unit. This means that, for different applications, a user must always use a lock device that corresponds to the application even if said applications do not occur simultaneously, and must keep a separate key or memorize a separate number combination, at least insofar as said combination is not arbitrary, for each of these lock devices.

### SUMMARY

In an exemplary embodiment, the present invention provides a lock device. The lock device includes: a first lock body; and a second lock body; wherein the first and second lock bodies are configured to be interlocked. The lock device further includes: an electromagnetic locking device, formed separately from the first and second lock bodies, wherein a first portion of the electromagnetic locking device is configured to be inserted into the first lock body, and a second portion of the electromagnetic locking device is configured to be inserted into the second lock body, and wherein each of the first and second portions of the electromagnetic locking device comprises a latching element, wherein each latching element is configured to lock a respective portion of the electromagnetic locking device to a respective lock body.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a first embodiment of a lock device according to the invention.

FIG. 2 shows the use of a same locking device as described in FIG. 1 in conjunction with another pair of two lock bodies.

FIG. 3 shows possible drive variants of the latching elements in the locking device.

### DETAILED DESCRIPTION

Exemplary embodiments of the invention provide a lock device and a locking device that are usable together, and/or a set comprising devices of this kind, which can be more universally employed, in particular such that a user can always unlock the lock bodies and/or separate them from one another in the same way, despite different applications.

In an exemplary embodiment, the present invention provides a lock device of the type mentioned at the outset, which additionally comprises a locking device that is formed separately from the first and second lock bodies, in particular an electromechanical locking device, a first portion of which can be inserted into the first lock body and a second portion of which can be inserted into the second lock body, and each portion comprises at least one latching element, via which the relevant portion can be locked to the relevant lock body.

In a further exemplary embodiment, the present invention provides a locking device that comprises a first portion and a second portion, it being possible for the first portion to be inserted into a first lock body of a lock device and the second portion to be inserted into a second lock body of a lock device, in particular the same lock device, and each portion comprising at least one latching element, via which the relevant portion can be locked to the relevant lock body.

Exemplary embodiments of the invention provide that the locking device is formed, contrary to the previous prior art, by a unit that is structurally separate from the lock bodies, and thus a locking device of this kind can be used together with a first pair of lock bodies and as well as with at least one additional pair of lock bodies, optionally any number of additional pairs, it being possible for the different pairs of lock bodies to be adapted to different applications.

For example, a pair of lock bodies, together with a locking device of this kind, can form a lock device in the manner of a padlock, or another pair of lock bodies can form a bicycle lock. The type and number of applications is unrestricted in this case, and the same locking device can always be used in each of the different applications.

This is particularly advantageous because a user thus only has to make use of one type of access to/unlocking of the locking device in order to use a locking device of this kind, and therefore every pair of lock bodies can be locked/unlocked in the same way.

This is also advantageous from a cost perspective, since the locking mechanisms of locking devices are usually particularly expensive, in particular when high safety ratings are to be complied with. A locking mechanism of this kind only needs to be purchased once due to the multiple uses of a locking device according to the invention.

The invention provides for the two lock bodies of a lock device according to the invention to be interlocked not directly, but indirectly via the structurally separate locking device, i.e. for a first lock body to be able to be locked to the locking device, whereby said body and device can no longer be separated from one another without authorization to unlock, and a second lock body can also be locked to the locking device, such that said body and device can no longer be separated from one another without authorization to unlock.

The lock bodies therefore do not have to be locked to one another, although a design can additionally provide this, but rather in each case to the locking device, and are therefore only indirectly locked to one another.

In this way, lock devices can also be formed which are not necessarily intended for securing other objects, but rather the lock device itself can form an object in which two parts, which are referred to according to the invention as the two lock bodies, can be separated from one another only when authorization is available, namely for unlocking the locking device.

In a preferred embodiment, the invention can provide for the locking device, which is structurally separate from the lock bodies, to be able to be surrounded in its entirety by the first and second lock bodies. In particular, this is understood to mean that the locking device can be completely received in an inner chamber that is formed by two lock bodies together. In this case, the locking device is no longer accessible from the outside after being locked to each of the two lock bodies.

For this case, it is particularly advantageous when unlocking and, optionally, locking of the locking device is achieved via radio communication between the locking device and a preferably mobile communication device (e.g. a mobile telephone). For this purpose, the locking device can comprise integrated electronics, e.g. a communication unit.

An electronic/electrical interface can, however, also be present between the locking device and at least one of the lock bodies, via which interface signals from one or both of the lock bodies can be communicated to the locking device for the purpose of unlocking and/or locking, e.g. from an input unit (e.g. keypad or touch-sensitive display) on at least one of the lock bodies.

Data that can be entered into an input unit of this kind, e.g. security codes for locking and/or unlocking, such as PIN codes, can thus be communicated internally between the relevant lock body and the locking device via an interface of this kind.

A memory can be provided in a lock body having an input unit of this kind and/or a locking device, in which memory at least one security code, in particular a PIN code, via which it is possible to lock and/or unlock the locking device, can be stored.

The invention can provide for this memory to be modifiable externally, e.g. via telecommunication, preferably via a mobile network (e.g. Global System for Mobile Communications (GSM)). For example, security codes can be changed in this way.

In this case, it is also possible for a plurality of locking devices, e.g. of one user, to be able to be locked and/or unlocked using the same security code, and, in the case of all of said plurality of locking devices, for the security code that is valid therefor to be able to be written to the relevant memory and/or changed in every memory. This can be achieved e.g. centrally via a server from a telecommunications network, e.g. from the mobile network. A user can thus reprogram e.g. all of his locking devices in one step, virtually simultaneously, with regard to the security codes.

In order to ensure that the locking device is integrally received in the lock bodies in a simple manner, it can be provided for the two portions of the locking device to be formed so as to be mirror-symmetric with respect to one another, regarding a plane of symmetry, or so as to be identical to one another, at least with regard to the lock configuration, preferably with regard to the entire external design. The portions adjoin one another preferably directly, and/or are separated only by the mathematical plane of symmetry.

Accordingly, the inner regions of the lock bodies, in which a relevant portion of a locking device can be received, can also be identical in shape.

This thus also ensures that both the first and the second portions of a locking device can be inserted into the inner region of the first lock body. The same also applies to the second lock body. A user therefore does not need to pay attention to the direction in which a locking device is to be inserted into a lock body.

In a preferred embodiment, the geometric shape of each of the two portions of a locking device, and in each case the inner regions of the lock bodies that receive said portions, is formed as mutually corresponding positive and negative forms.

Instead of the preferred symmetrical embodiment, the portions can also be differently shaped, an inner region of a lock body, allocated in each case to a portion, is then explicitly adapted to the portion to be received.

In a preferred embodiment, the locking device can have a simple geometric basic shape, e.g. a cuboid shape, preferably having rounded corners, in order to facilitate insertion into the lock bodies. In this embodiment, and/or in general, division into the two portions is possible, e.g. along the direction of longitudinal extension of the locking device. In particular, the locking device can be divided equally into the two portions in this direction.

Merely at least one latching element per portion, preferably two opposing latching elements per portion, project outwards from the outer contour of a housing, preferably a housing that is formed as a geometric basic shape. Functional elements (optionally identical per portion) can optionally also project outwards from the outer contour of the housing, which elements form a mechanical and/or electrical operative connection with one or both of the lock bodies.

The invention can provide for the latching element(s) of the two portions to be formed as bodies that can be moved out of and into the housing of the locking device, in particular as bodies of which the mobility can be blocked, and which can be brought into engagement with corresponding undercuts or recesses in the lock bodies during locking.

Bodies and/or latching elements of this kind can be e.g. force-loaded outwards, in particular by respective magnetic fields, preferably respective permanent magnets that—preferably repulsively—influence respective magnetic or magnetizable latching elements, or can be spring-loaded, such that the latching elements/bodies automatically catch in corresponding recesses/undercuts inside the lock bodies when employed. By blocking the mobility of the latching elements, locking is thus also possible.

It is possible for all the latching elements of the locking device or at least all the latching elements of a relevant portion, to be able to be blocked with regard to mobility via a common blocking element, preferably a blocking element that can be operated in a motorized manner by an actuator, e.g. a stopper that can be slid in a longitudinal direction of the locking device. For this purpose, a region of the blocking element that blocks movement can be moved to be behind a relevant latching element, after said element has adopted an outwardly displaced position.

The latching elements and/or the movable bodies that form said elements can, however, also be actively moved by an actuator, preferably in each case into a position protruding from the outer contour of the housing or into a position retracted into the housing.

Levers, gear mechanisms or at least one electromagnetic drive can be provided for this purpose, in particular in the latter case the movement of the latches in at least one or both of the two positions resulting from a magnetically exerted force, for which purpose the latches are preferably magnetic or at least magnetizable and cooperate with at least one controllable electromagnet, via which the latches can be rerouted into the relevant position.

In this case, too, the latching elements can be preloaded by spring-loading or by a magnetically generated force, preferably into the locking position protruding from the contour of the housing, and can be retracted by electromagnetically generated magnetic force at least intermittently.

The latching element(s) of the two portions can preferably comprise a common drive. In one embodiment it can also be possible, however, for a separate drive/actuator to be provided for the latches of each portion, in particular whereby the possibility arises of optionally only unlocking one of the two lock bodies of the locking device.

The structural design can, in all the embodiments, preferably be such that the direction of movement of a relevant latching element is perpendicular to the direction of insertion of the locking device and a relevant lock body.

The invention can additionally provide for an interface for conducting electrical signals between the locking device and a relevant lock body to be arranged on at least one of the portions, in particular on an end face of the at least one portion which is arranged perpendicularly to the direction of insertion of the locking device and a relevant lock body.

As already mentioned at the outset, an interface of this kind can relay electrical/electronic signals (in particular also data) between the locking device and at least one of the lock bodies.

An embodiment can also provide, in this case, for an electrical safety loop and/or an antenna to be connectable via the interface to a lock body comprising electronics in the locking device. Severing, for example, a conductor in an electrical safety loop, which conductor is arranged on one or both of the lock bodies, in particular which conductor connects the lock bodies, can thus be checked, e.g. by resistance measuring, or current and/or voltage measuring.

The connection of an antenna, e.g. on the outside of at least one of the lock bodies, to the locking device via an interface of this kind additionally ensures good radio reception, even when the lock bodies are metal and would therefore shield a communication unit, formed in the electronics, in the interior of the locking device.

In a development that can be combined with all of the above-mentioned embodiments, it is also possible for at least one of the lock bodies to comprise a locking mechanism, which can be operated via at least one latching element of at least one of the portions of the locking device.

In this case, the locking mechanism of a lock body, which mechanism can achieve additional, in particular direct interlocking of the lock bodies, uses the drives of the latches of the locking device. Operating said drives thus simultaneously results in operation of the locking mechanism of one or both of the lock bodies.

In one embodiment, the two lock bodies can be formed as separate components. However, they can also be interconnected, e.g. via a band or belt or tube or cable. An aforementioned element of this kind can form at least one electrical line, in particular for forming a safety loop that is checked for destruction, between the lock bodies.

The locking device can preferably comprise a telecommunications unit, in particular in the electronics mentioned at the outset or separately thereto, and at least one actuator of the locking device can be controlled by telecommunication between said electronics and an in particular mobile telecommunications device of a user, for the purpose of locking and/or unlocking. An actuator of this kind can directly drive either an aforementioned blocking element or the latching elements themselves.

For example, this can be achieved via an application on the mobile communication device of the user. The communication can occur over the near field (preferably less than 100 meters or less than 10 meters or less than 1 meter), e.g. via Bluetooth, wireless local area network (WLAN) or radio-frequency identification (RFID). A mobile communications system over a mobile network can also be provided. In this case, the locking device preferably has a subscriber identity module (SIM) card functionality. For example, the locking device can be locked and/or unlocked by sending SMS or other short messages to the communication unit thereof

Embodiments will be described with reference to the following figures.

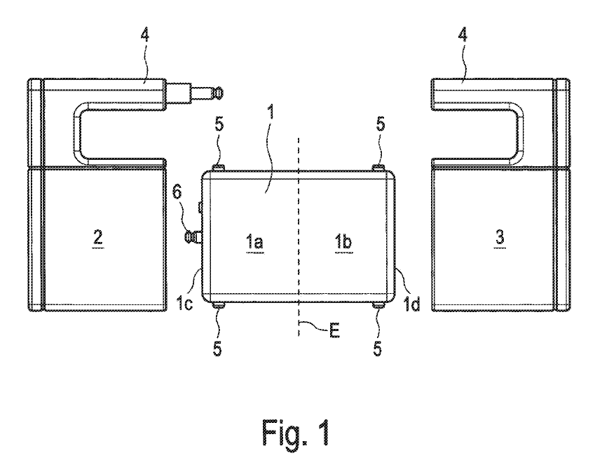

FIG. 1 shows a first embodiment of a lock device according to the invention, which is formed by a locking device 1 according to the invention and two lock bodies 2 and 3.

The locking device 1 is a structurally separate unit from the lock bodies and comprises, on both sides of the plane of symmetry E, shown here in dashed lines, two identically shaped portions 1a and 1b. The plane of symmetry E separates these portions in the longitudinal direction of the locking device.

Each of the portions is intended to be received in a corresponding inner region in a relevant lock body 2, 3. In this case, with reference to FIG. 1, the two lock bodies 2 and 3 can therefore be slid in each case onto the portions 1a, 1b, as a result of which the locking device is completely received in the interior of the two lock bodies and is no longer accessible/visible from the outside.

The two lock bodies, which are interlocked indirectly via the locking device, here form a lock device in the style of a padlock, after being placed onto the locking device, as a result of the shackle 4.

The locking device comprises latching elements 5 in the corner regions of each portion, which elements are movable perpendicularly to the direction of plugging between the locking device 1 and the lock bodies 2, 3 and can be blocked in the extended position shown here, for which purpose electromechanical operation, arranged in the locking device, can be provided.

Functional elements 6 can be provided on the end faces 1c and/or 1d that face the lock bodies 2, 3, which elements form an operative connection with the lock bodies. In this case, a functional element 6 is provided on the end face 1c. An operative connection of this kind can be mechanical or electrical/electronic. For example, electrical signals can be transmitted via said connection, e.g. radio signals.

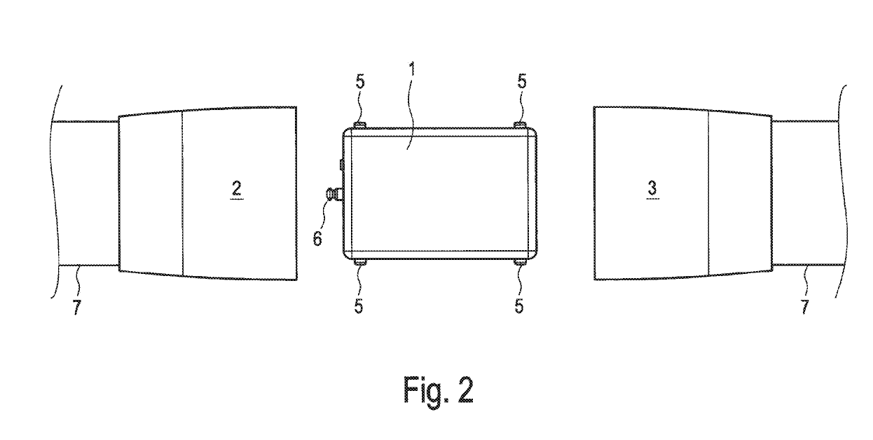

FIG. 2 shows the use of the same locking device 1, as described in FIG. 1, in conjunction with another pair of two lock bodies 2, 3. In this case, the two lock bodies 2, 3 are interconnected by a belt or a band 7. An electrical conductor, for example, can be passed through the belt 7, which conductor also connects the lock bodies 2, 3.

FIG. 2 makes it clear that a user has the option of using the same locking device 1 together with different pairs of lock bodies 2, 3, and thus of opening up various possible applications, e.g. in the manner of a bicycle lock in FIG. 2, in which case the belts are guided through openings/wheels of the bicycle.

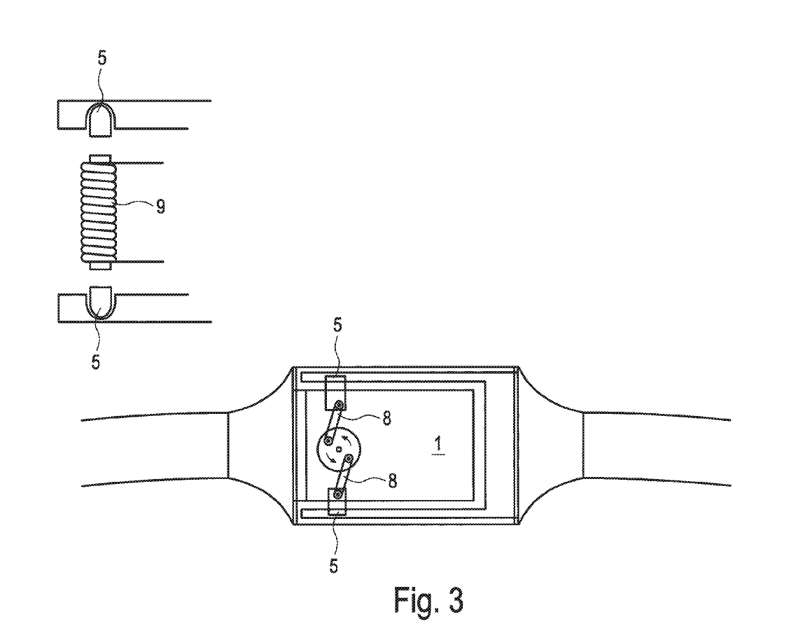

FIG. 3 shows possible drive variants of the latching elements 5 in the locking device 1. For example, it is possible for the latching elements 5 to be able to be moved between the locking position and a releasing position via a mechanism of levers 8, which are hinged eccentrically on a rotatable disk.

Another variant can provide for magnetic or at least magnetizable latching elements 5 to be drawn into an unlocking position via an electromagnet 9.

In the locking position, the latching elements 5 can be force-loaded, e.g. by a permanent magnetic field, or spring-loaded. Here, every two opposing latching elements 5, in particular those of one of the portions 1a, 1b, can be force-loaded via a common electromagnet. An identical arrangement is provided in the second portion.

A communication unit may also be provided in the locking device 1, and a power supply may be provided by a rechargeable battery that can be charged e.g. via a charging port arranged on the outside of the housing or by induction. Commands for locking and/or unlocking can be received from a preferably mobile communication device of a user via the communication unit.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A lock device, comprising:
a first lock body; and
a second lock body;
wherein the first and second lock bodies are configured to be interlocked;
wherein the lock device further comprises:
an electromagnetic locking device, formed separately from the first and second lock bodies, wherein a first portion of the electromagnetic locking device is configured to be inserted into the first lock body, and a second portion of the electromagnetic locking device is configured to be inserted into the second lock body, and wherein each of the first and second portions of the electromagnetic locking device comprises a latching element, wherein each latching element is configured to lock a respective portion of the electromagnetic locking device to a respective lock body.

2. A locking device, comprising:
a first portion; and
a second portion;
wherein the first portion is configured to be inserted into a first lock body of a lock device and the second portion is configured to be inserted into a second lock body of the lock device, and wherein each portion comprises a latching element, wherein each latching element is configured to lock a respective portion to a respective lock body.

3. The lock device according to claim 1, wherein the electromagnetic locking device is configured to be surrounded in its entirety by the first and second lock bodies and is configured to be completely received in an inner chamber formed by the first and second lock bodies together.

4. The lock device according to claim 1, wherein the first and second portions of the electromagnetic locking device are formed so as to be mirror-symmetric at least with regard to the latching, arrangement.

5. The lock device according to claim 1, wherein the inner regions of the first and second lock bodies are configured to receive respective portions of the electromagnetic locking device and are identical in shape.

6. The lock device according to claim 1, wherein the latching elements of the first and second portions are configured to be moved out of and into the housing of the electromagnetic locking device, wherein the housing of the electromagnetic locking device comprises undercuts or recesses corresponding to the latching elements for locking the latching elements.

7. The lock device according to claim 6, wherein the direction of movement of a respective latching element is perpendicular to the direction of insertion of the electromagnetic locking device into a respective lock body.

8. The lock device according to claim 1, wherein the latching elements of the first and second portions comprise a common drive or a common element that blocks the mobility of the latching elements.

9. The lock device according to claim 1, wherein an interface for conducting electrical signals between the electromagnetic locking device and a respective lock body is arranged at an end face of a respective portion, wherein the end face is arranged perpendicularly to the direction of insertion of the electromagnetic locking device and the respective lock body; and
wherein an electrical safety loop and/or an antenna and/or an input unit is configured to be connected to electronics in the electromagnetic locking device via the interface.

10. The lock device according to claim 1, wherein a keypad or a touch-sensitive display is arranged on a respective lock body, and wherein an interface is configured to transmit PIN code data from the respective lock body to the electromagnetic locking device for locking and or unlocking,

11. The lock device according to claim 1, wherein the electromagnetic locking device and/or at least one of the first and second lock bodies comprises a memory having at least one stored PIN code for locking and/or unlocking the electromagnetic locking device; and wherein contents of the memory are changeable via telecommunication.

12. The lock device according to claim 1, wherein at least one of the first and second lock bodies comprises a locking mechanism configured to be operated via at least one latching element of at least one of the first and second portions of the electromagnetic locking device.

13. The lock device according to claim 1, wherein the first and second lock bodies are formed as separate components or are interconnected via a band, belt tube or cable, wherein the band, belt, tube or cable comprise at least one electrical line between the first and second lock bodies.

14. The lock device according to claim 1, wherein the electromagnetic locking device comprises a telecommunications unit, and at least one actuator of the electromagnetic locking device is configured to be controlled via telecommunication between the telecommunication unit and a mobile telecommunications unit of a user for locking and/or unlocking.

15. A set of lock devices, comprising:
a first lock body and a second lock body, wherein the first and second lock bodies are configured to be interlocked;
a third lock body and a fourth lock body, wherein the third and fourth lock bodies are configured to be interlocked;
wherein the set of lock devices further comprises:
electromagnetic locking device, formed separately from the first, second, third and fourth lock bodies, wherein a first portion of the electromagnetic locking device is configured to be inserted into the first lock body and the third lock body, and a second portion of the electromagnetic locking device is configured to be inserted into the second lock body and the fourth lock body, and wherein each of the first and second portions of the electromagnetic locking device comprises a latching element, wherein each latching element is configured to lock a respective portion of the electromagnetic locking device to a respective lock body.

16. The lock device according to claim 1, wherein the lock device is a padlock or a bicycle lock.
